(19) United States
(12) Patent Application Publication
(10) Pub. No.: US 2012/0037559 A1
(43) Pub. Date: Feb. 16, 2012

(54) STRAINER FILTERING APPARATUS INCLUDING FILTERING TUBE

(75) Inventors: Sang-Yeol Kim, Daejeon (KR); Hyeong Teak Kim, Daejeon (KR); Chang-Hyun Kim, Daejeon (KR); Sang Won Lee, Daejeon (KR); Jong In Woo, Gyeongsangnam-do (KR)

(73) Assignees: BHI CO., LTD., Gyeongsangnam-do (KR); KOREA HYDRO & NUCLEAR POWER CO., LTD., Seoul (KR)

(21) Appl. No.: 12/875,252

(22) Filed: Sep. 3, 2010

(30) Foreign Application Priority Data
Aug. 12, 2010 (KR) 2010-0077640

(51) Int. Cl. B01D 29/15

(52) U.S. Cl. 210/323.2

(57) ABSTRACT

A strainer filtering apparatus including a filtering tube providing a substantially larger effective filtering area for its length and width, substantially reducing foreign substances covering a suction surface and flow resistance of the foreign substances, and reducing pressure drop at a cooling water passage. The strainer filtering apparatus includes at least one inlet side into which cooling water is introduced and an outlet side through which the cooling water is discharged, hollow filtering tubes with filtering holes along their lengths, an upper plate having first grooves located at a lower surface and coupled to upper ends of the filtering tubes and an inlet part into which the cooling water is introduced, and a lower plate having punched holes to which lower ends of the filtering tubes are coupled. The cooling water in the filtering tubes is introduced through the punched holes and discharged at the outlet side.

### TECHNICAL FIELD

The present invention relates to a strainer filtering apparatus (referred to as a passive filtering apparatus) for filtering foreign substances, settlings, etc., generated upon occurrence of failures or accidents of an apparatus requiring a water circulation system, and more particularly, to a strainer filtering apparatus including a filtering tube used to remove foreign substances from a fluid suctioned into a pipe and a re-circulation pump when the re-circulation pump goes through an operation of an emergency core cooling system (ECCS) when a pipe failure occurs in a nuclear power plant.

### BACKGROUND ART

A nuclear reactor of a nuclear power plant is surrounded by a safety vessel formed of concrete and steel, which is referred to as a containment, in which a coolant circulates to maintain a proper temperature. In addition, the nuclear reactor includes an ECCS for cooling the nuclear reactor upon occurrence of failures or accidents.

The ECCS must be operated upon occurrence of accidents such as coolant leakage, etc., to cool the nuclear reactor for 30 days with no external interference. The ECCS is a system for collecting coolant discharged and water sprinkled upon a pipe failure into a sump disposed at the lowermost part in the containment, sprinkling the water from an upper part of the containment using the re-circulation pump to cool the containment, and circulating some of the water through a nuclear reactor cooling system to remove remaining heat of the nuclear reactor using a remaining heat removing pump.

When coolant leakage occurs due to damage to a pipe, etc., in a primary system of the nuclear power plant, foreign substances such as lagging materials, coating materials, latent foreign substances, etc., are generated due to discharge of a coolant.

In addition, the discharged coolant and water sprinkled from a sprinkler system of the containment move all foreign substances to a re-circulation sump disposed at a lower end of the containment of the nuclear reactor. Therefore, in order for the foreign substances not to decrease performance of the ECCS, a filtering apparatus is provided in front of an inlet part of a suction pipe guided to an emergency cooling pump.

When a high temperature and high pressure pipe is broken, foreign substances such as fragments of lagging materials, coating materials, etc., are generated and moved toward the sump, and the filtering apparatus functions to filter the foreign substances moved to the sump and supply the filtered water into the re-circulation pump, without interfering with the operation of the re-circulation pump.

The filtering apparatus ensures that the foreign substances generated due to accidents can be filtered and the water can appropriately pass therethrough. In this case, a pressure drop due to the foreign substances must be guaranteed not to exceed an allowable critical value.

A conventional filter screen used in a pressurized water reactor type nuclear power plant has a small screen surface only, and the screen surface is mainly formed of flat grid segments. Thus, when the screen surface is contaminated with fiber settlings, a pressure drop at the screen may be largely increased to an unallowable level.

However, the filtering apparatus having a single surface may be easily deformed by a high pressure, and a small effective filtering area per a unit volume may decrease filtering efficiency. In order to solve the problem, while the number of filtering apparatus may be increased, their installation cost is high, which causes economical problems. Therefore, a filtering apparatus capable of increasing a filtering area per unit volume is still needed.

### SUMMARY OF THE INVENTION

In order to solve the foregoing and/or other problems, it is an aspect of the present invention to provide a strainer filtering apparatus including a filtering tube capable of providing a substantially larger effective filtering area in the same length and width, substantially reducing foreign substances covering a suction surface and a flow resistance of the foreign substances, and reducing a pressure drop at a cooling water pass corresponding thereto.

It is another aspect of the present invention to provide a strainer filtering apparatus including a filtering tube capable of reducing manufacturing and installation costs to solve economical problems in exchange and installation thereof, rapidly manufacturing the apparatus by assembling a relatively small number of components, and maximizing a filtering area per unit volume even in a narrow space.

The foregoing and/or other aspects of the present invention may be achieved by providing a strainer filtering apparatus including at least one inlet side into which cooling water is introduced and an outlet side through which the cooling water is discharged, including: a plurality of filtering tubes formed in a hollow shape by bending a punched plate having a plurality of filtering holes; an upper plate having first grooves formed at a lower surface to be coupled to upper ends of the filtering tubes and an inlet part into which the cooling water is introduced; and a lower plate having punched holes into which lower ends of the filtering tubes are coupled, wherein the filtered cooling water in the filtering tubes is introduced through the punched holes to be discharged to the outlet side.

The first grooves may be formed in plural, and the punched holes may be formed in plural at positions corresponding to the first grooves so that the plurality of filtering tubes are coupled between the upper plate and the lower plate.

The cooling water may be introduced into a space between the upper plate and the lower plate to contact outer surfaces of the plurality of filtering tubes.

The cooling water contacting the outer surfaces may be filtered to be introduced into discharge cams in the filtering tubes.

The plurality of first grooves may form a first groove arrangement group in which grooves are spaced a predetermined distance from a center of the upper plate and spaced a predetermined interval from each other, and the plurality of punched holes may be formed to correspond to the first grooves.

The first groove arrangement group may be formed on the upper plate in plural, and the upper ends of the filtering tubes may be press-fitted into the first grooves.

The punched holes may have a diameter equal to an inner diameter of the filtering tubes, and the lower plate may further include second grooves formed around the punched holes and equal to an outer diameter of the filtering tubes, whereby the lower ends of the filtering tubes are press-fitted into the second grooves of the lower plate.

The strainer filtering apparatus may further include a coupling member installed between the upper and lower plates to couple the upper and lower plates to fix the filtering tubes between the upper and lower plates.

The coupling member may include at least one fixing pin installed in a space between the upper and lower plates and fastening members for fastening both ends of the fixing pin to the upper and lower plates.

The strainer filtering apparatus may further include a fixing member installed at one side of the lower plate and coupling the lower plate to the passage through which the cooling water flows.

The fixing member may be provided around the lower plate in plural. The filtering holes may have a diameter of 1 to 3 mm.

According to a strainer filtering apparatus of the present invention, it is possible to provide a substantially larger effective filtering area in the same length and width. Therefore, a flow resistance of settlings and foreign substances covering a suction surface can be substantially reduced. In addition, a pressure drop generated along the strainer filtering apparatus can be reduced depending on reduction in flow resistance.

Further, since the strainer filtering apparatus of the present invention is fabricated by assembling a filtering tube formed of a punched plate, an upper plate and a lower plate, without welding, it is possible to easily perform maintenance and installation thereof. Furthermore, since a plurality of filtering tubes formed of a punched outer surface are vertically disposed, a load pressure can be distributed to increase structural integrity.

In addition, it is possible to provide the strainer filtering apparatus capable of being rapidly assembled with a relatively small number of components, and maximizing a filtering area per unit volume even in a narrow space.

### BRIEF DESCRIPTION OF DRAWINGS

The above and other aspects and advantages of the present invention will become apparent and more readily appreciated from the following description of exemplary embodiments, taken in conjunction with the accompanying drawings of which:

FIG. 1 is a perspective view of a strainer filtering apparatus in accordance with an exemplary embodiment of the present invention;

FIG. 2 is a bottom view of the strainer filtering apparatus in accordance with an exemplary embodiment of the present invention;

FIG. 3 is a plan view of the strainer filtering apparatus in accordance with an exemplary embodiment of the present invention;

FIG. 4 is a perspective view of a filtering tube in accordance with an exemplary embodiment of the present invention;

FIG. 5 is a perspective view of an upper plate in accordance with an exemplary embodiment of the present invention;

FIG. 6 is a bottom view of the upper plate in accordance with an exemplary embodiment of the present invention;

FIG. 7 is a plan view of the upper plate in accordance with an exemplary embodiment of the present invention;

FIG. 8 is a perspective view of a lower plate in accordance with an exemplary embodiment of the present invention;

FIG. 9 is a bottom view of the lower plate in accordance with an exemplary embodiment of the present invention;

FIG. 10 is a plan view of the lower plate in accordance with an exemplary embodiment of the present invention; and

FIG. 11 is an exploded perspective view of the strainer filtering apparatus in accordance with an exemplary embodiment of the present invention.

### DETAILED DESCRIPTION

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concept to those skilled in the art.

In the drawings, like reference numerals designate like elements throughout the invention.

Hereinafter, constitution and structure of a strainer filtering apparatus 10 in accordance with an exemplary embodiment of the present invention will be described.

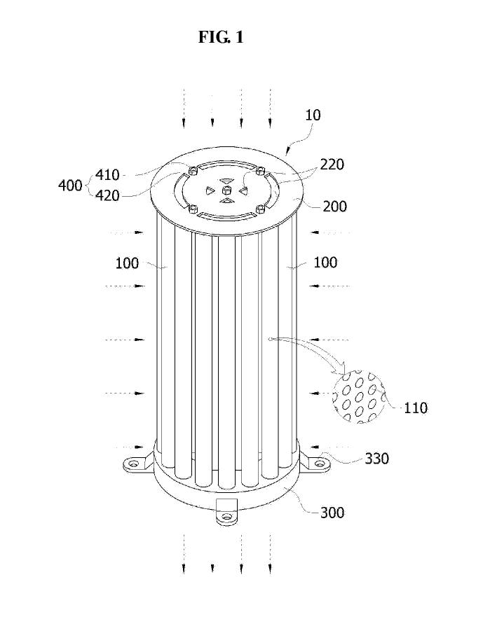

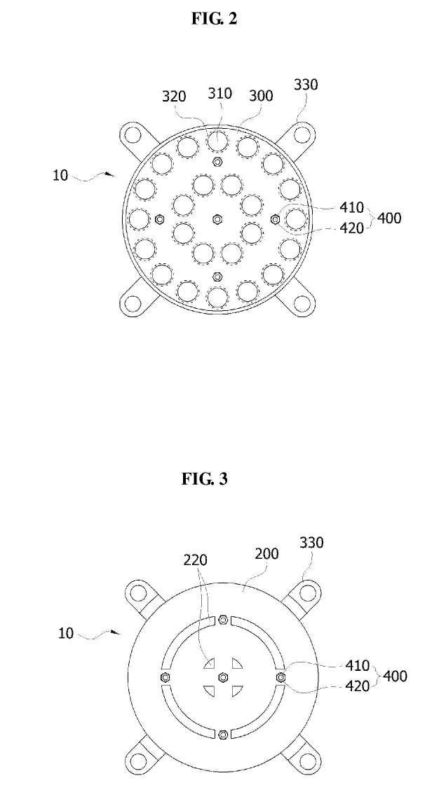

FIG. 1 is a perspective view of a strainer filtering apparatus 10 in accordance with an exemplary embodiment of the present invention, FIG. 2 is a bottom view of the strainer filtering apparatus 10 in accordance with an exemplary embodiment of the present invention, and FIG. 3 is a plan view of the strainer filtering apparatus 10 in accordance with an exemplary embodiment of the present invention.

As shown in FIG. 1, the strainer filtering apparatus 10 in accordance with the present invention includes a plurality of filtering tubes 100 formed of a punched surface. In addition, the strainer filtering apparatus 10 includes an upper plate 200 having first grooves 210 and inlet parts 220 formed in a lower surface, a lower plate 300 having a plurality of punched holes 310, second grooves 320 formed in an upper surface and fixing members 330 formed at a periphery, and coupling members 400 for coupling the upper plate 200 and the lower plate 300.

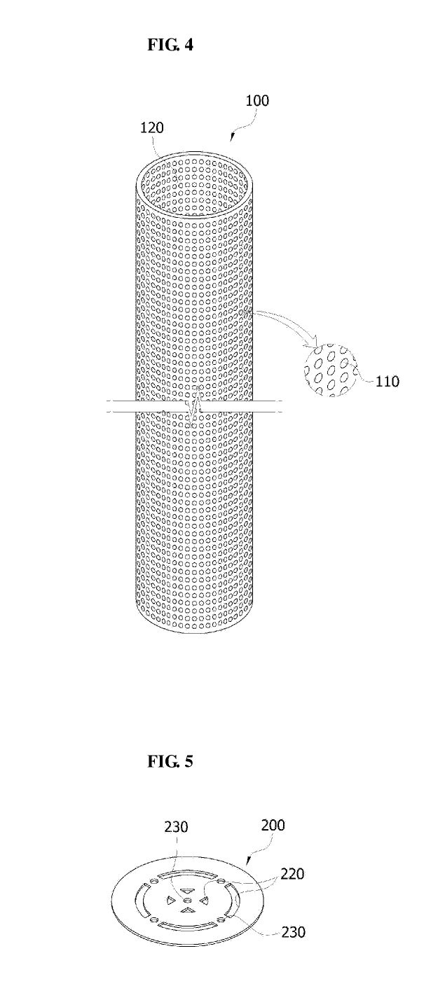

FIG. 4 is a perspective view of a filtering tube 100 in accordance with an exemplary embodiment of the present invention.

As shown in FIG. 4, the filtering tube 100 is hollow and formed of a punched surface. A punched plate having a plurality of filtering holes 110 is bent to form the filtering tube 100. The filtering holes 110 formed in the filtering tube 100 may have a diameter of about 1 to 3 mm, preferably, 2 to 2.5 mm. In this embodiment, the filtering tube 100 has an outer diameter of 40 mm and an inner diameter of 36 mm. A discharge cam 120 is formed in an inner space of the filtering tube 100 to discharge the filtered cooling water to the outlet side. The strainer filtering apparatus 10 in accordance with an exemplary embodiment of the present invention includes a plurality of filtering tubes 100.

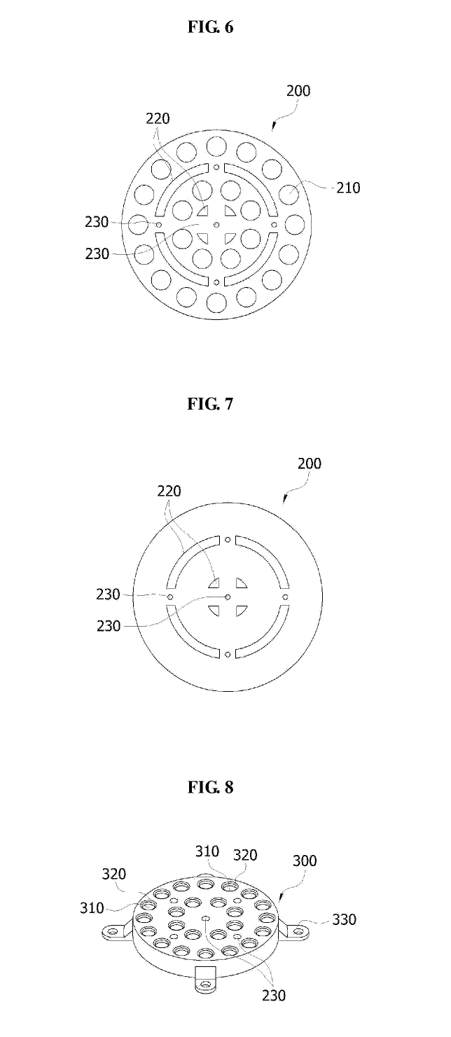

FIG. 5 is a perspective view of an upper plate 200 in accordance with an exemplary embodiment of the present invention, FIG. 6 is a bottom view of the upper plate 200 in accordance with an exemplary embodiment of the present invention, and FIG. 7 is a plan view of the upper plate 200 in accordance with an exemplary embodiment of the present invention.

As shown in FIGS. 5 to 7, the upper plate 200 includes inlet parts 220 through which cooling water is introduced. The inlet parts 220 may have various shapes, regardless of the shapes shown in FIGS. 5 to 7. In addition, the upper plate 200 includes fixing holes 230 to be coupled to the lower plate 300 by coupling members 400.

As shown in FIG. 6, the upper plate 200 has a plurality of first grooves 210 formed in a lower surface thereof. Upper ends of the filtering tubes 100 are press-fitted into the plurality of first grooves 210. Therefore, the first grooves 210 have a diameter equal to an outer diameter of the filtering tubes 100. In addition, the number of the first grooves 210 formed in the lower surface of the upper plate 200 is equal to the number of the filtering tubes 100 installed in the strainer filtering apparatus 10. In this embodiment, the number of the first grooves 210 is 24.

As shown in FIG. 6, the first grooves 210 have an arrangement group in which the first grooves 210 are spaced a predetermined distance from a center of the upper plate 210 and spaced apart from each other at predetermined intervals. In this embodiment, the first grooves 210 have two arrangement groups. In addition, the first grooves 210 are formed in the lower surface, in which the fixing holes 230 and the inlet parts 220 are not disposed. The diameter and number of the first grooves 210, the shape of the arrangement groups and number of the first grooves 210 will be understood not to be limited to the specific embodiment.

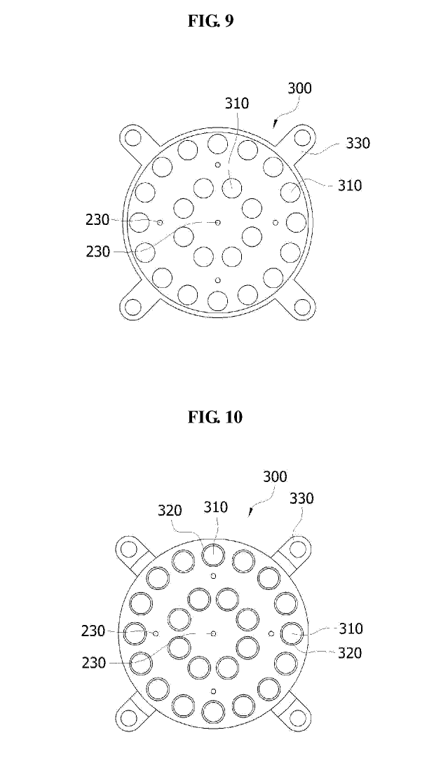

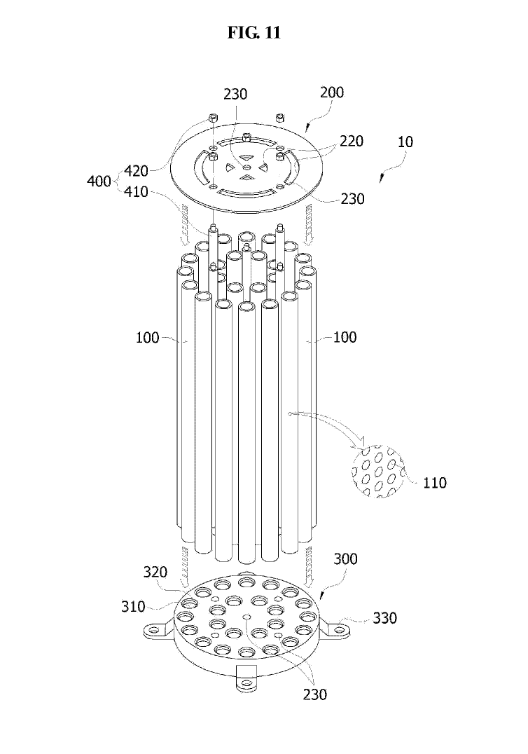

FIG. 8 is a perspective view of a lower plate 300 in accordance with an exemplary embodiment of the present invention, FIG. 9 is a bottom view of the lower plate 300 in accordance with an exemplary embodiment of the present invention, and FIG. 10 is a plan view of the lower plate 300 in accordance with an exemplary embodiment of the present invention.

As shown in FIGS. 8 to 10, the lower plate 300 includes a plurality of punched holes 310. In addition, second grooves 320 are formed around the punched holes 320 of an upper surface of the lower plate 300. The punched holes 310 of the lower plate 300 have a diameter equal to an inner diameter of the filtering tubes 100, and the second grooves 320 have a diameter equal to an outer diameter of the filtering tubes 100.

Therefore, lower ends of the plurality of filtering tubes 100 may be press-fitted into the second grooves 320 of the lower plate 300. The punched holes 310 and the second grooves 320 of the lower plate 300 are arranged to correspond to the first grooves 210 of the upper plate 200. That is, the first grooves 210 of the upper plate 200 and the punched holes 310 and the second grooves 320 of the lower plate 300 are formed at symmetrical positions.

In addition, the lower plate 300 also includes fixing holes 230 like the upper plate 200. As shown in FIGS. 8 to 10, it will be appreciated that the fixing holes 230 formed in the lower plate 300 also correspond to the fixing holes 230 formed in the upper plate 200.

Further, the lower plate 300 includes fixing members 330. As shown in FIGS. 8 to 10, the lower plate 300 includes four fixing members 330 formed around the lower plate 300 and spaced a predetermined interval from each other. The lower plate 300 is fixedly installed at one side of the passage, through which cooling water flows, by the fixing members 330.

FIG. 11 is an exploded perspective view of the strainer filtering apparatus in accordance with an exemplary embodiment of the present invention.

As shown in FIG. 11, upper ends of the plurality of filtering tubes 100 are press-fitted into the first grooves 210 of the upper plate 200, respectively. On the other hand, lower ends of the plurality of filtering tubes 100 are press-fitted into the second grooves 320 of the lower plate 300, respectively.

In addition, the coupling members 400 are installed between the upper plate 200 and the lower plate 300 of the strainer filtering apparatus 10. The coupling members 400 couple the upper plate 200 and the lower plate 300 while maintaining a gap between the upper plate 200 and the lower plate 300. Specifically, the coupling members 400 include fixing pins 410 and fastening members 420. The fixing pins 410 have threads formed at both ends thereof. In addition, both ends of the fixing pins 410 are inserted into the fixing holes 230 of the upper plate 200 and the fixing holes 230 of the lower plate 300, and fixed to the upper plate 200 and the lower plate 300 by the fastening members 420 such as nuts, etc. Therefore, the coupling members 400 couple the upper plate 200 and the lower plate 300 and fix the filtering tubes 100 between the upper plate 200 and the lower plate 300.

According to the above constitution, the cooling water introduced into the inlet part 220 of the upper plate 200 is introduced into a space between the upper plate 200 and the lower plate 300 to contact outer surfaces of the plurality of filtering tubes 100, and the cooling water contacting the outer surfaces of the filtering tubes 100 is introduced into the discharge cams 120 in the filtering tubes 100 to be filtered. Then, the filtered cooling water is discharged from the discharge cams 120 of the filtering tubes 100 to the outlet side through the punched holes 310 of the lower plate 300.

The strainer filtering apparatus 10 including a filtering tube in accordance with an exemplary embodiment of the present invention can effectively increase a filtering area even under internal conditions of a narrow containment. In addition, since the apparatus is designed as a modular structure constituted by the filtering tubes 100, the upper plate 200, the lower plate 300, and the coupling members 400, installation and maintenance thereof is very easy. Further, in comparison with a conventional filtering apparatus having a single surface, it is possible to minimize deformation even under a high pressure and increase a filtering area per unit volume, securing safety of a recirculation operation of an ECCS when a pipe failure occurs in a nuclear power plant. Furthermore, the present invention can be applied to all pressurized water reactor type and pressurized heavy water reactor type nuclear power plants.

The foregoing description concerns an exemplary embodiment of the invention, is intended to be illustrative, and should not be construed as limiting the invention. The present teachings can be readily applied to other types of devices and apparatus. Many alternatives, modifications, and variations within the scope and spirit of the present invention will be apparent to those skilled in the art.

1. A strainer filtering apparatus comprising:
at least one inlet side into which cooling water is introduced and an outlet side through which the cooling water is discharged;
a plurality of hollow filtering tubes having lengths and a plurality of filtering holes along the length;
an upper plate having first grooves located at a lower surface coupled to upper ends of the filtering tubes and an inlet part into which the cooling water is introduced; and
a lower plate having punched holes at which lower ends of the filtering tubes are coupled to the lower plate, wherein the cooling water in the filtering tubes is introduced through the punched holes and discharged from the outlet side.

2. The strainer filtering apparatus according to claim 1, wherein the first grooves and the punched holes are located at positions corresponding to the first grooves so that the plurality of filtering tubes are coupled between the upper plate and the lower plate.

3. The strainer filtering apparatus according to claim 2, wherein the cooling water is introduced into a space between the upper plate and the lower plate to contact outer surfaces of the plurality of filtering tubes.

4. The strainer filtering apparatus according to claim 3, wherein the cooling water contacting the outer surfaces is filtered and introduced into discharge cams in the filtering tubes.

5. The strainer filtering apparatus according to claim 2, wherein the first grooves form a first groove arrangement group in which grooves are spaced a predetermined distance from a center of the upper plate and spaced a predetermined interval from each other, and the punched holes are located in correspondence with the first grooves.

6. The strainer filtering apparatus according to claim 5, including a plurality of the first groove arrangement groups located on the upper plate, and the upper ends of the filtering tubes are press-fitted into the first grooves.

7. The strainer filtering apparatus according to claim 6, wherein
the punched holes have a diameter equal to an inner diameter of the filtering tubes, and
the lower plate further includes second grooves located around the punched holes and equal to an outer diameter of the filtering tubes, and the lower ends of the filtering tubes are press-fitted into the second grooves of the lower plate.

8. The strainer filtering apparatus according to claim 2, further comprising a coupling member located between the upper and lower plates and coupling the upper and lower plates to fix the filtering tubes between the upper and lower plates.

9. The strainer filtering apparatus according to claim 8, wherein the coupling member includes at least one fixing pin located in a space between the upper and lower plates and fastening members fastening respective ends of the fixing pin to the upper and lower plates.

10. The strainer filtering apparatus according to claim 2, further comprising a fixing member located at one side of the lower plate and coupling the lower plate to the passage through which the cooling water flows.

11. The strainer filtering apparatus according to claim 10, including a plurality of the fixing members located around the lower plate.

12. The strainer filtering apparatus according to claim 1, wherein the filtering holes have a diameter in a range from 1 to 3 mm.
